(19) United States
(12) Patent Application Publication
(10) Pub. No.: US 2024/0383724 A1
(43) Pub. Date: Nov. 21, 2024

(54) ELEVATOR SYSTEM WITH BRAKE FAILURE RESPONSES

(71) Applicant: Otis Elevator Company, Farmington, CT (US)

(72) Inventor: Steven Michael Millett, Plainville, CT (US)

(21) Appl. No.: 18/318,664

(22) Filed: May 16, 2023

(51) Int. Cl. B66B 5/02; B66B 1/02; B66B 5/00

(52) U.S. Cl. CPC B66B 5/027; B66B 1/02; B66B 5/0031; B66B 5/02; B66B 1/36

(57) ABSTRACT

A method of operating an elevator system is provided and includes recognizing that brakes of an elevator car fail to drop upon brake power being removed, temporarily hovering the elevator car in place to allow the elevator car to be emptied, controllably moving the elevator car in a direction of imbalance, which is defined in terms of relative weights of the elevator car and a counter-weight and torque applied to the elevator car for driving the elevator car upwardly or downwardly, to either a top or a bottom of a hoistway and confirming that the brakes are failing to drop or provide sufficient holding torque.

### BACKGROUND

The present disclosure relates to elevator systems and, in particular, to an elevator system with brake failure responses.

In current elevator systems, there are certain responses to many faults, such as brake related faults. These responses include, but are not limited to, the elevator drive system, which can be a sub-system of an elevator controller that is responsible for motor power and control, executing the following process: emergency stop, removal of motor torque and a subsequent drop of the electro-mechanical brakes. In these or other cases, if there is truly a problem with the electro-mechanical brakes and they do not drop or fail to provide sufficient holding torque, the elevator will go into free-fall. To avoid free fall, there is redundancy built into the electro-mechanical brakes and so it is extremely rare for a total electro-mechanical brake failure.

Despite the effectiveness of redundancies in elevator systems, new building codes around the world are requiring additional safeguards against free fall and other similar hazards.

### SUMMARY

According to an aspect of the disclosure, a method of operating an elevator system is provided and includes recognizing that brakes of an elevator car fail to drop upon brake power being removed, temporarily hovering the elevator car in place to allow the elevator car to be emptied, controllably moving the elevator car in a direction of imbalance, which is defined in terms of relative weights of the elevator car and a counter-weight and torque applied to the elevator car for driving the elevator car upwardly or downwardly, to either a top or a bottom of a hoistway and confirming that the brakes are failing to drop or provide sufficient holding torque.

In accordance with additional or alternative embodiments, prior to the recognizing, the elevator car arrives at a destination, the brakes are commanded to drop and brake power is removed.

In accordance with additional or alternative embodiments, the brakes include electro-mechanical brakes.

In accordance with additional or alternative embodiments, the brakes include hydraulic-mechanical brakes.

In accordance with additional or alternative embodiments, the temporarily hovering of the elevator car in place includes temporarily hovering the elevator car in place to allow people in the elevator car to exit the elevator car.

In accordance with additional or alternative embodiments, the confirming includes performing a test of the brakes.

In accordance with additional or alternative embodiments, the method further includes placing the elevator car back in service upon a successful execution of the test.

In accordance with additional or alternative embodiments, the performing includes permitting the elevator car to fall upwardly at the top of the hoistway in an event the brakes fail the test.

According to an aspect of the disclosure, a method of operating an elevator system is provided and includes recognizing that brakes of an elevator car drop upon brake power being removed, ramping down torque of a drive system that drives upward and downward movement of the elevator car, determining whether the elevator car moves due to the ramping down of the torque and taking an action in accordance with a result of the determining.

In accordance with additional or alternative embodiments, the brakes include electro-mechanical brakes.

In accordance with additional or alternative embodiments, the brakes include hydraulic-mechanical brakes

In accordance with additional or alternative embodiments, the method further includes waiting between the recognizing and the ramping down.

In accordance with additional or alternative embodiments, the ramping down continues until the torque is zeroed.

In accordance with additional or alternative embodiments, the method further includes maintaining the drive system in an active state with the torque zeroed.

In accordance with additional or alternative embodiments, the taking of the action includes increasing the torque in an event the result of the determining indicates that the elevator car moves due to the ramping down of the torque.

In accordance with additional or alternative embodiments, the method further includes maintaining the torque to drive the elevator car to a top of a hoistway in which the elevator car is disposed.

In accordance with additional or alternative embodiments, the taking of the action includes idling the drive system in an event the result of the determining indicates that the elevator car does not move due to the ramping down of the torque.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an elevator system in accordance with embodiments;

FIG. 2 is a flow diagram illustrating a method of operating an elevator system for verifying that electro-mechanical brakes of the elevator system are dropping correctly in accordance with embodiments; and

FIG. 3 is a flow diagram illustrating a method of operating an elevator system for verifying that electro-mechanical brakes of the elevator system are dropping correctly in accordance with embodiments.

### DETAILED DESCRIPTION

As will be described below, an elevator system is provided to execute a process. The process that can be followed by the drive system of the elevator system to verify that electro-mechanical or hydraulic-mechanical brakes of the elevator system are dropping correctly and holding the elevator car before removal of motor torque. Several existing features, including “hovering,” which is defined as an elevator car being held in place at 0 speed by a drive and a motor, and “brake torque inspection,” can be extended and used to keep passengers safe in the event of a brake failure. The drive itself can function to detect brake failure, allow passengers to safely evacuate the car and then to move the car to the top of the hoistway to minimize any further damage.

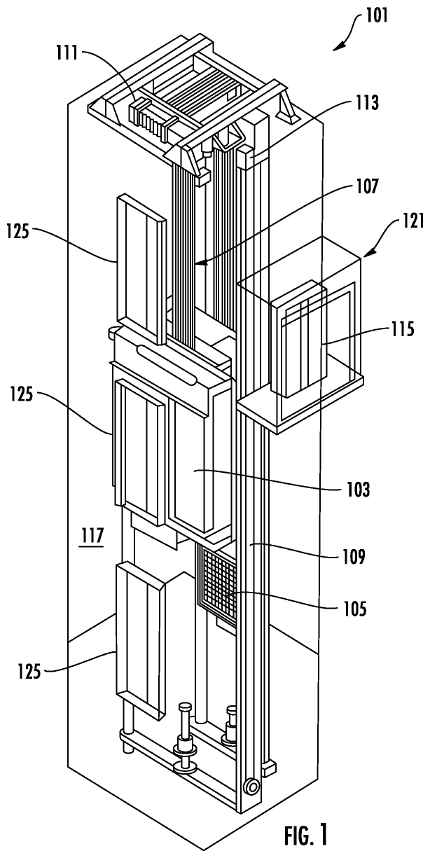

With reference to FIG. 1, which is a perspective view of an elevator system 101, the elevator system 101 includes an elevator car 103, a counterweight 105, a tension member 107, a guide rail 109, a machine 111, a position reference system 113 and a controller 115. The elevator car 103 and the counterweight 105 are connected to each other by the tension member 107. The tension member 107 may include or be configured as, for example, ropes, steel cables and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be integrally attached to the elevator car 103 or the elevator door 104 may be located on a landing 125 of the elevator system 101, or both. Embodiments disclosed herein may be applicable to both an elevator door 104 integrally attached to the elevator car 103 or an elevator door 104 located on a landing 125 of the elevator system 101, or both. The elevator door 104 opens to allow passengers to enter and exit the elevator car 103.

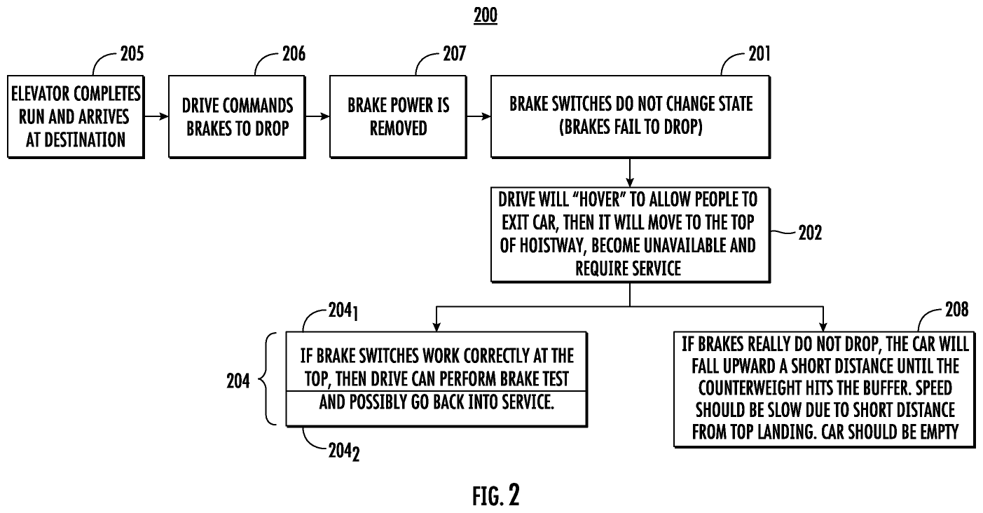

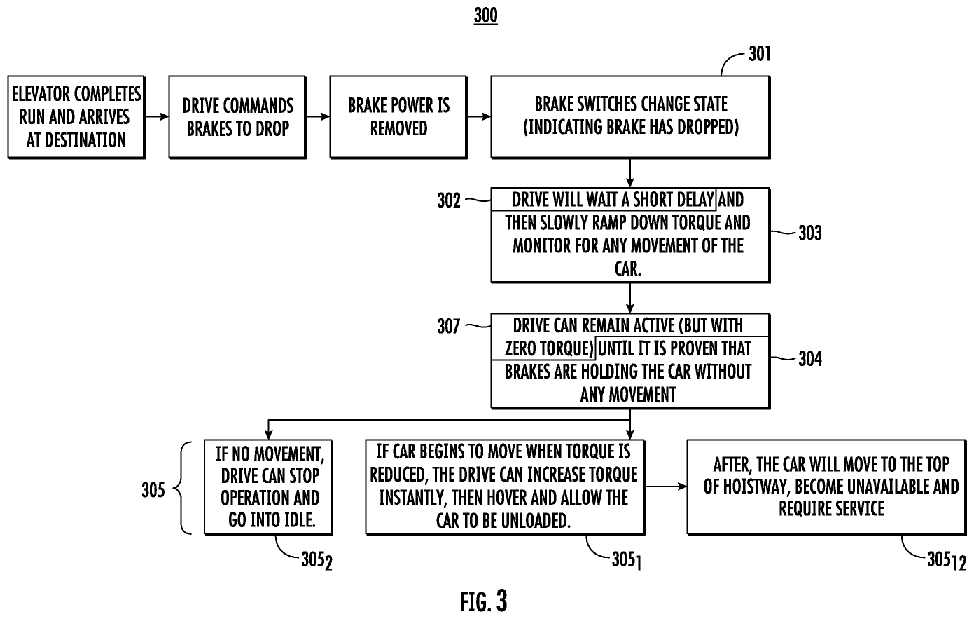

With reference to FIGS. 2 and 3, the elevator system 101 of FIG. 1 is configured to execute methods for verifying that electro-mechanical or hydraulic-mechanical brakes of the elevator system 101 are dropping correctly.

As shown in FIG. 2, a first method 200 of operating the elevator system 101 (i.e., the machine 111, the position reference system 113 and the controller 115 of FIG. 1) for verifying that electro-mechanical brakes of the elevator system 101 are dropping correctly is provided. The first method 200 includes recognizing that brakes of an elevator car (i.e., electro-mechanical or hydraulic-mechanical brakes) fail to drop upon brake power being removed (block 201), temporarily hovering the elevator car in place to allow people inside the elevator car to exit the elevator car and for the elevator car to be emptied at least of people (block 202), controllably moving the elevator car in a direction of imbalance, which is defined in terms of a weight of the elevator car, a weight of a counter-weight and torque applied to the elevator car by the machine to drive the elevator car upwardly or downwardly, to either a top or a bottom of a hoistway in order to minimize falling distance if the brakes truly fail to hold the elevator car (block 203) and confirming that the brakes are failing to drop or provide sufficient holding torque at a top (or bottom) of a hoistway in which the elevator car is disposed (block 204). Prior to the recognizing, the elevator car will have completed a run and arrived at a destination (block 205), the brakes will have been commanded to drop (block 206) and brake power will have been removed (block 207).

In accordance with embodiments, the confirming of block 204 can include performing a test of the brakes (block 2041) whereupon the elevator car can be placed back in service upon a successful execution of the test (block 2042). Alternatively, in an event the brakes fail the test, the first method 200 can further include permitting the elevator car to fall upwardly at the top of the hoistway (block 208). In this case, the speed of the elevator car falling upward should be relatively low due to the short distance to the top landing that would be in effect. In any case, the elevator car would be empty during the test and, where applicable, the upward falling.

As shown in FIG. 3, a second method 300 of operating the elevator system 101 (i.e., the machine 111, the position reference system 113 and the controller 115 of FIG. 1) for verifying that electro-mechanical or hydraulic-mechanical brakes of the elevator system 101 are dropping correctly is provided. The second method includes recognizing that brakes of an elevator car (i.e., electro-mechanical or hydraulic-mechanical brakes) drop upon brake power being removed (block 301), waiting for a predefined period of time (block 302), ramping down torque of a drive system that drives upward and downward movement of the elevator car (block 303), determining whether the elevator car moves due to the ramping down of the torque to zero in some cases (block 304) and taking an action in accordance with a result of the determining (block 305). The ramping down of the torque can continue until the torque is zeroed and the second method 300 can further include maintaining the drive system in an active state with the torque zeroed (block 307).

In accordance with embodiments, the taking of the action of block (305) can include increasing the torque in an event the result of the determining indicates that the elevator car moves due to the ramping down of the torque (block 3051) and then maintaining the torque to drive the elevator car to a top of a hoistway in which the elevator car is disposed (block 30512) or idling the drive system in an event the result of the determining indicates that the elevator car does not move due to the ramping down of the torque (block 3052).

Technical effects and benefits of the present disclosure are the provision of a process that is executable by a drive system of an elevator system to meet new requirements for confirming that electro-mechanical or hydraulic-mechanical brakes are dropping correctly. The process is far more cost-effective than adding additional hardware to short a motor winding.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A method of operating an elevator system, the method comprising:
recognizing that brakes of an elevator car fail to drop upon brake power being removed;
temporarily hovering the elevator car in place to allow the elevator car to be emptied;
controllably moving the elevator car in a direction of imbalance, which is defined in terms of relative weights of the elevator car and a counter-weight and torque applied to the elevator car for driving the elevator car upwardly or downwardly, to either a top or a bottom of a hoistway; and
confirming that the brakes are failing to drop or provide sufficient holding torque.

2. The method according to claim 1, wherein, prior to the recognizing, the elevator car arrives at a destination, the brakes are commanded to drop and brake power is removed.

3. The method according to claim 1, wherein the brakes comprise electro-mechanical brakes.

4. The method according to claim 1, wherein the brakes comprise hydraulic-mechanical brakes.

5. The method according to claim 1, wherein the temporarily hovering of the elevator car in place comprises temporarily hovering the elevator car in place to allow people in the elevator car to exit the elevator car.

6. The method according to claim 1, wherein the confirming comprises performing a test of the brakes.

7. The method according to claim 6, further comprising placing the elevator car back in service upon a successful execution of the test.

8. The method according to claim 6, wherein the performing comprises permitting the elevator car to fall upwardly at the top of the hoistway in an event the brakes fail the test.

9. A method of operating an elevator system, the method comprising:
recognizing that brakes of an elevator car drop upon brake power being removed;
ramping down torque of a drive system that drives upward and downward movement of the elevator car;
determining whether the elevator car moves due to the ramping down of the torque; and
taking an action in accordance with a result of the determining.

10. The method according to claim 9, wherein the brakes comprise electro-mechanical brakes.

11. The method according to claim 9, wherein the brakes comprise hydraulic-mechanical brakes.

12. The method according to claim 9, further comprising waiting between the recognizing and the ramping down.

13. The method according to claim 9, wherein the ramping down continues until the torque is zeroed.

14. The method according to claim 13, further comprising maintaining the drive system in an active state with the torque zeroed.

15. The method according to claim 9, wherein the taking of the action comprises increasing the torque in an event the result of the determining indicates that the elevator car moves due to the ramping down of the torque.

16. The method according to claim 9, further comprising maintaining the torque to drive the elevator car to a top of a hoistway in which the elevator car is disposed.

17. The method according to claim 9, wherein the taking of the action comprises idling the drive system in an event the result of the determining indicates that the elevator car does not move due to the ramping down of the torque.
